(19) United States
(12) Patent Application Publication
(10) Pub. No.: US 2025/0235958 A1
(43) Pub. Date: Jul. 24, 2025

(54) LASER PROCESSING APPARATUS, LASER PROCESSING SYSTEM, AND METHOD FOR MANUFACTURING ELECTRONIC DEVICES

(71) Applicant: Gigaphoton Inc., Tochigi (JP)

(72) Inventors: Tomonari TANAKA, Oyama-shi (JP); Yasufumi KAWASUJI, Oyama-shi (JP); Akira SUWA, Oyama-shi (JP); Osamu WAKABAYASHI, Oyama-shi (JP); Akiyoshi SUZUKI, Oyama-shi (JP)

(73) Assignee: Gigaphoton Inc., Tochigi (JP)

(21) Appl. No.: 18/967,082

(22) Filed: Dec. 3, 2024

(30) Foreign Application Priority Data
Jan. 22, 2024 (JP) 2024-007599

(51) Int. Cl. B23K 26/382; B23K 26/06; B23K 26/066; B23K 101/36; B23K 103/00

(52) U.S. Cl. CPC B23K 26/382; B23K 26/0648; B23K 26/066; B23K 2101/36; B23K 2103/54

(57) ABSTRACT

A laser processing apparatus includes: a first optical slit disposed at a first position in an optical path of laser light and having an opening extending in a second direction; a second optical slit disposed at a second position and having an opening extending in the first direction; an illumination optical system including a first light focusing optical system that focuses the laser light in the first direction to form laser light having a first linear shape and irradiates the first optical slit with the laser light, and a second light focusing optical system that focuses the laser light in the second direction to form laser light having a second linear shape and irradiates the second optical slit with the laser light; and a projection optical system that brings the laser light passing through the first and second optical slits into focus at a surface of a workpiece.

### CROSS-REFERENCE TO RELATED APPLICATIONS

The present application claims the benefit of Japanese Patent Application No. 2024-007599, filed on Jan. 22, 2024, the entire contents of which are hereby incorporated by reference.

### BACKGROUND

### 1. Technical Field

The present disclosure relates to a laser processing apparatus, a laser processing system, and a method for manufacturing electronic devices.

### 2. Related Art

In recent years, a semiconductor exposure apparatus is required to improve the resolution thereof as semiconductor integrated circuits are increasingly miniaturized and highly integrated. To this end, reduction in the wavelength of light emitted from a light source for exposure is underway. For example, a KrF excimer laser apparatus, which outputs laser light having a wavelength of about 248.0 nm, and an ArF excimer laser apparatus, which outputs laser light having a wavelength of about 193.4 nm, are used as a gas laser apparatus for exposure.

The excimer laser light, which has a pulse width of about several tens of nanoseconds and has a short wavelength of 248.0 nm or 193.4 nm, is further used in some cases to directly process a polymer material, a glass material, and other materials.

The excimer laser light having photon energy higher than the chemical binding energy of a polymer material can unbind the chemically bonded molecules that form the polymer material. Non-thermal processing can therefore be performed on a polymer material by using excimer laser light, and it is known that an excellent processed shape is achieved by the unheated processing.

Glass, ceramic, and other materials absorb excimer laser light by a large amount, and it is therefore known that excimer laser light can process a material difficult to process with visible or infrared laser light.

The light from spontaneously oscillating KrF and ArF excimer laser apparatuses has a wide spectral linewidth ranging from 350 pm to 400 pm. A projection lens made of a material that transmits ultraviolet light, such as KrF and ArF laser light, therefore produces chromatic aberrations in some cases. As a result, the resolution of the projection lens may decrease. To avoid the decrease in the resolution, the spectral linewidth of the laser light output from the gas laser apparatus needs to be narrow enough to make the chromatic aberrations negligible. To this end, a line narrowing module (LNM) including a line narrowing element (such as etalon or grating) is provided in some cases in a laser resonator of the gas laser apparatus to narrow the spectral linewidth. A gas laser apparatus providing a narrowed spectral linewidth is hereinafter referred to as a narrowed-line gas laser apparatus.

### CITATION LIST

### Patent Literature

[PTL 1] JP2008-060274A
[PTL 2] JP2018-025632A
[PTL 3] Japanese Patent No. 3,391,948
[PTL 4] JPH05-042381A
[PTL 5] JP2006-289443 A
[PTL 6] U.S. Pat. No. 5,237,149

### SUMMARY

A laser processing apparatus according to an aspect of the present disclosure is a laser processing apparatus for performing drilling by irradiating a workpiece with laser light output from a laser apparatus, the laser processing apparatus including: a first optical slit disposed at a first position in an optical path of the laser light and having an opening extending in a second direction perpendicular to a first direction; a second optical slit disposed at a second position different from the first position in the optical path of the laser light and having an opening extending in the first direction; an illumination optical system including a first light focusing optical system configured to focus the laser light in the first direction so as to form laser light having a first linear shape and irradiate the first optical slit with the laser light, and a second light focusing optical system configured to focus the laser light in the second direction so as to form laser light having a second linear shape and irradiate the second optical slit with the laser light; and a projection optical system configured to bring the laser light passing through the first and second optical slits into focus at a surface of the workpiece in such a way that the focused laser light have a shape of a portion where the opening of the first optical slit and the opening of the second optical slit overlap with each other.

A laser processing system according to another aspect of the present disclosure is a laser processing system for performing drilling by irradiating a workpiece with laser light output from a laser apparatus, the laser processing system including: the laser apparatus configured to output the laser light; a first optical slit disposed at a first position in an optical path of the laser light and having an opening extending in a second direction perpendicular to a first direction; a second optical slit disposed at a second position different from the first position in the optical path of the laser light and having an opening extending in the first direction; an illumination optical system including a first light focusing optical system configured to focus the laser light in the first direction so as to form laser light having a first linear shape and irradiate the first optical slit with the laser light, and a second light focusing optical system configured to focus the laser light in the second direction so as to form laser light having a second linear shape and irradiate the second optical slit with the laser light; and a projection optical system configured to bring the laser light passing through the first and second optical slits into focus at a surface of the workpiece in such a way that the focused laser light have a shape of a portion where the opening of the first optical slit and the opening of the second optical slit overlap with each other.

A method for manufacturing electronic devices according to another aspect of the present disclosure is a method for manufacturing electronic devices, the method including: forming multiple through holes in a glass substrate as a workpiece by using a laser processing apparatus configured to perform drilling by irradiating the workpiece with laser light output from a laser apparatus; coupling and electrically connecting an interposer including the glass substrate and a conductor provided in each of the multiple through holes to an integrated circuit chip; and coupling and electrically connecting the interposer to a circuit substrate, the laser processing apparatus including a first optical slit disposed at a first position in an optical path of the laser light and having an opening extending in a second direction perpendicular to a first direction, a second optical slit disposed at a second position different from the first position in the optical path of the laser light and having an opening extending in the first direction, an illumination optical system including a first light focusing optical system configured to focus the laser light in the first direction so as to form laser light having a first linear shape and irradiate the first optical slit with the laser light, and a second light focusing optical system configured to focus the laser light in the second direction so as to form laser light having a second linear shape and irradiate the second optical slit with the laser light, and a projection optical system configured to bring the laser light passing through the first and second optical slits into focus at a surface of the workpiece in such a way that the focused laser light have a shape of a portion where the opening of the first optical slit and the opening of the second optical slit overlap with each other.

### BRIEF DESCRIPTION OF DRAWINGS

Embodiments of the present disclosure will be described below only by way of example with reference to the accompanying drawings.

FIG. 1 schematically shows the configuration of a laser processing system according to Comparative Example.

FIG. 2 schematically shows the configuration of a laser apparatus.

FIG. 3 schematically shows the beam shape of laser light taken along a VH plane along the line A-A shown in FIG. 2.

FIG. 4 schematically shows the shape of the laser light radiated to a mask.

FIG. 5 schematically shows the configuration of a laser processing system according to a first embodiment.

FIG. 6 shows a first beam waist position and a second beam waist position.

FIG. 7 schematically shows the beam shape of the laser light taken along a VH plane along the line B-B shown in FIG. 6.

FIG. 8 schematically shows the beam shape of the laser light taken along a VH plane along the line C-C shown in FIG. 6.

FIG. 9 schematically shows the configuration of a first optical slit.

FIG. 10 schematically shows the configuration of a second optical slit.

FIG. 11 schematically shows the shape of an image formed at a surface of a workpiece.

FIG. 12 shows the configurations of an illumination optical system and a projection optical system according to a first variation.

FIG. 13 schematically shows the configuration of a laser processing system according to a second variation.

FIG. 14 schematically shows the configuration of a laser processing system according to a third variation.

FIG. 15 schematically shows the shape of an opening of a diaphragm that can make the shape of an image close to a circular shape.

FIG. 16 schematically shows the shape of an opening of the first optical slit that can make the shape of the image close to a circular shape.

FIG. 17 schematically shows the shape of an opening of the second optical slit that can make the shape of the image close to a circular shape.

FIG. 18 schematically shows the configuration of a laser processing system according to a second embodiment.

FIG. 19 shows the procedure of drilling operation according to the second embodiment.

FIG. 20 schematically shows the configuration of a laser processing system according to a first variation.

FIG. 21 shows the procedure of drilling operation according to the first variation.

FIG. 22 shows a variation of the illumination optical system.

FIG. 23 schematically shows the configuration of a laser processing system according to a second variation.

FIG. 24 shows the procedure of drilling operation according to the second variation.

FIG. 25 schematically shows the configuration of a laser apparatus according to a variation.

FIG. 26 schematically shows the beam shape of the laser light taken along a VH plane along the line D-D shown in FIG. 25.

FIG. 27 schematically shows the configuration of a fixed-magnification beam expander.

FIG. 28 schematically shows the configuration of a variable-magnification beam expander.

FIG. 29 schematically shows the configuration of the variable-magnification beam expander.

FIG. 30 schematically shows the configuration of an optical axis monitor.

FIG. 31 partially shows the illumination optical system and the projection optical system according to a variation.

FIG. 32 diagrammatically shows the configuration of an electronic device.

FIG. 33 shows a method for manufacturing the electronic devices.

### DETAILED DESCRIPTION

### <Contents>

1. Description of terms
1.1 Diffractive optical element
2. Comparative Example
2.1 Configuration
2.2 Operation
2.3 Problems
3. First Embodiment
3.1 Configuration
3.2 Operation
3.3 Effects
4. Variations of first embodiment
4.1 First variation
4.1.1 Configuration
4.1.2 Operation
4.1.3 Effects
4.2 Second variation
4.2.1 Configuration
4.2.2 Operation
4.2.3 Effects
4.3 Third variation
4.3.1 Configuration
4.3.2 Operation
4.3.3 Effects
4.4 Other variations
5. Second Embodiment
5.1 Configuration
5.2 Operation
5.3 Effects
6. Variations of second embodiment
6.1 First variation
6.1.1 Configuration
6.1.2 Operation
6.1.3 Effects
6.2 Second variation
6.2.1 Configuration
6.2.2. Operation
6.2.3 Effects
7. Variation of laser apparatus
8. Beam expander
9. Optical axis monitor
10. Variation of optical apparatus
11. Method for manufacturing electronic devices
12. Example of configuration of laser processing processor

Embodiments of the present disclosure will be described below in detail with reference to the drawings. The embodiments described below show some examples of the present disclosure and are not intended to limit the contents of the present disclosure. Furthermore, all configurations and operations described in the embodiments are not necessarily essential as configurations and operations in the present disclosure. The same elements have the same reference characters, and no redundant description of the same elements will be made.

### 1. Description of Terms

### 1.1 Diffractive Optical Element

A diffractive optical element (DOE) is an optical element that utilizes the phenomenon of diffraction of light. For example, a DOE is produced by processing a fine structure designed through a simulation on a substrate using a fine processing technology. A DOE can convert laser light into light having any of a variety of patterns. In the present disclosure, a DOE converts laser light into light having a multi-point pattern.

### 2. Comparative Example

### 2.1 Configuration

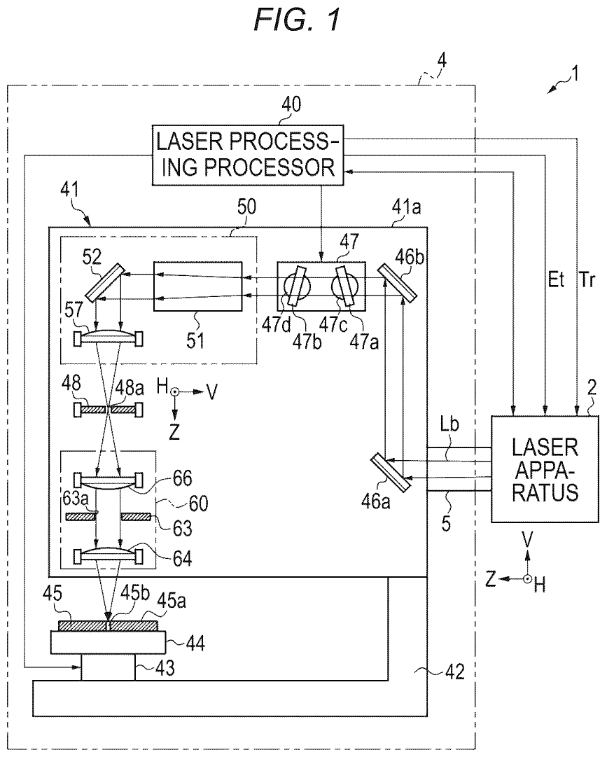

FIG. 1 schematically shows the configuration of a laser processing system 1 according to Comparative Example. Comparative Example is a form that the applicant is aware of as known only by the applicant, and is not a publicly known example that the applicant is self-aware of.

The laser processing system 1 includes a laser apparatus 2 and a laser processing apparatus 4 as primary components. The laser processing system 1 is used to perform drilling operation of forming holes such as via holes in a glass substrate for an interposer.

The laser apparatus 2 is a laser apparatus that outputs ultraviolet pulse laser light. For example, the laser apparatus 2 is a discharge-excitation-type laser apparatus containing F₂, ArF, KrF, XeCl, or XeF as a laser medium and outputting ultraviolet pulse laser light. In the present disclosure, the laser apparatus 2 is a KrF excimer laser apparatus that outputs ultraviolet pulse laser light having a center wavelength of 248.0 nm. The ultraviolet pulse laser light output by the laser apparatus 2 will hereinafter be simply referred to as laser light Lb.

The laser apparatus 2 and the laser processing apparatus 4 are connected to each other via an optical path tube 5. The optical path tube 5 is disposed in the optical path of the laser light Lb between a light exiting port of the laser apparatus 2 and a light incident port of the laser processing apparatus 4.

In the present disclosure, the traveling direction of the laser light Lb output from the laser apparatus 2 is referred to as a Z direction, and the direction perpendicular to the Z direction and corresponding to the discharge direction in the laser apparatus 2 is referred to as a V direction, and the direction perpendicular to the Z and V directions is referred to as an H direction. In an optical apparatus 41, the traveling direction of the laser light Lb changes when reflected off each highly reflective mirror, which will be described later. In the optical apparatus 41, the traveling direction of the laser light Lb output from an illumination optical system 50, which will be described later, is defined as the Z direction. Also in the optical apparatus 41, the V direction is perpendicular to the Z direction, and is a direction relatively corresponding to the discharge direction. The V direction corresponds to the “first direction” according to the technology described in the present disclosure. The H direction corresponds to the “second direction” according to the technology described in the present disclosure.

The laser processing apparatus 4 includes a laser processing processor 40, the optical apparatus 41, a frame 42, a moving stage 43, and a table 44. The optical apparatus 41 and the moving stage 43 are fixed to the frame 42.

The table 44 supports a workpiece 45. The workpiece 45 is a machining target on which drilling is performed. The workpiece 45 is a glass substrate for an interposer, and is, for example, an alkali-free glass substrate. Note that the workpiece 45 may be a substrate made of quartz glass, an organic material, silicon single crystal, or a ceramic material. In Comparative Example, a hole 45b is formed in the workpiece 45.

The moving stage 43 supports the table 44. The workpiece 45 is fixed onto the table 44. The moving stage 43 allows the table 44 to move in the V, H, and Z directions, and moves the table 44 to change the position of the workpiece 45. The V and H directions are parallel to a surface 45a of the workpiece 45. The Z direction is perpendicular to the surface 45a.

The optical apparatus 41 includes an enclosure 41a, highly reflective mirrors 46a and 46b, an attenuator 47, the illumination optical system 50, a mask 48, and a projection optical system 60. The constituent members in the optical apparatus 41 are fixed to respective holders that are not shown, and disposed at predetermined positions in the enclosure 41a.

The highly reflective mirror 46a is disposed so as to reflect the laser light Lb having passed through the optical path tube 5, and cause the reflected laser light Lb to be incident on the highly reflective mirror 46b. The optical path tube 5 and the enclosure 41a are purged, for example, with a purge gas. The purge gas is, for example, a nitrogen gas or an inert gas, and is a gas that hardly absorbs the laser light Lb.

The attenuator 47 is disposed in the enclosure 41a in the optical path of the laser light Lb reflected off the highly reflective mirror 46b. The attenuator 47 includes, for example, two partially reflective mirrors 47a and 47b, and rotary stages 47c and 47d for the partially reflective mirrors 47a and 47b. The partially reflective mirrors 47a and 47b are optical elements having transmittance that changes in accordance with the angle of incidence of the laser light Lb. The angle of incidence of the laser light Lb to be incident on the partially reflective mirrors 47a and 47b is adjusted by the rotary stages 47c and 47d, respectively.

The illumination optical system 50 includes a beam expander 51, a highly reflective mirror 52, and a light focusing optical system 57. The beam expander 51 is disposed in the optical path of the laser light Lb having passed through the attenuator 47 so as to increase the beam diameter of the incident laser light Lb at the same magnification in the V and H directions and output the expanded laser light. In Comparative Example, the beam expander 51 has a fixed magnification.

The highly reflective mirror 52 is disposed so as to reflect the laser light Lb output from the beam expander 51 and cause the reflected laser light Lb to enter the light focusing optical system 57. The light focusing optical system 57 is, for example, a convex lens having a spherical surface.

The mask 48 is disposed at the back focal position of the light focusing optical system 57. The mask 48 has a single circular opening 48a formed therein, and is illuminated with the laser light Lb focused by the light focusing optical system 57. Furthermore, the mask 48 is so disposed that the laser light Lb having passed through the opening 48a is brought into focus by the projection optical system 60 at a predetermined projection magnification on the surface 45a of the workpiece 45. Note that the opening 48a is not limited to a physical through hole, and may be a transmissive region that transmits the laser light Lb.

The projection optical system 60 includes a collimation optical system 66, a diaphragm 63, and an imaging optical system 64. The collimation optical system 66 is, for example, a convex lens having a spherical surface, and is so disposed that the position of the mask 48 coincides with the front focal position of the collimation optical system 66.

The diaphragm 63 is disposed in the optical path of the laser light Lb collimated by the collimation optical system 66, and has, for example, a square opening 63a formed so as to have a predetermined numerical aperture.

The imaging optical system 64 is, for example, a convex lens having a spherical surface, and is so disposed that an image of the laser light Lb representing the shape of the opening 48a of the mask 48 is formed at the back focal position of the imaging optical system 64.

The laser processing processor 40 is configured to be capable of transmitting target pulse energy Et and a light emission trigger signal Tr to the laser apparatus 2, and transmitting and receiving other signals to and from the laser apparatus 2. The target pulse energy Et is a target value of the pulse energy of the laser light Lb. The light emission trigger signal Tr is a trigger signal that causes the laser apparatus 2 to output one pulse of laser light Lb.

The laser processing processor 40 is also a control apparatus that controls the laser apparatus 2 and the moving stage 43 in such a way that an area to be processed at a step position where drilling is required at the surface 45a of the workpiece 45 is irradiated with the laser light Lb in a step-and-repeat manner. The laser processing processor 40 is an example of the “processor” according to the technology described in the present disclosure.

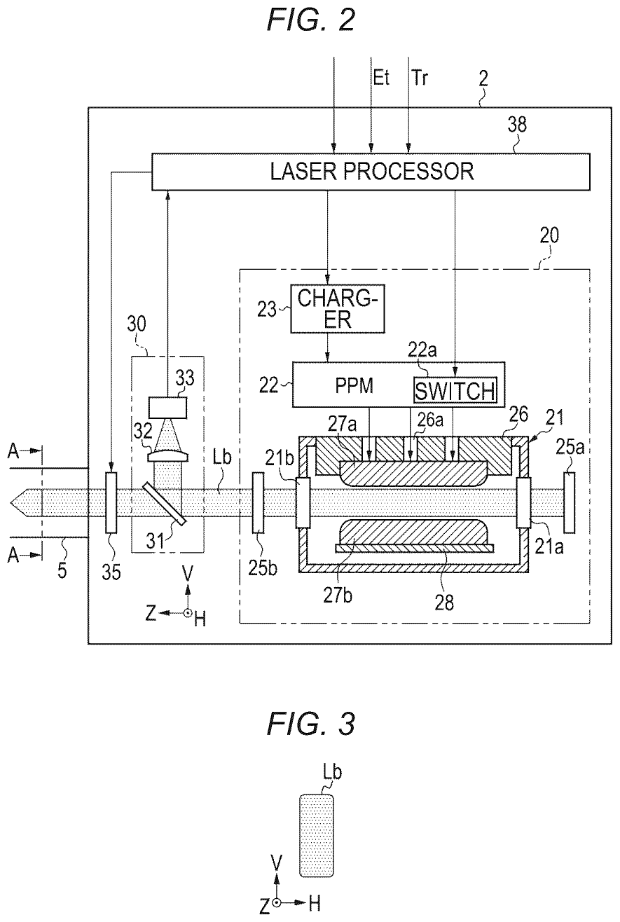

FIG. 2 schematically shows the configuration of the laser apparatus 2. The laser apparatus 2 includes an oscillator 20, a monitor module 30, a shutter 35, and a laser processor 38. The oscillator 20 includes a chamber 21, an optical resonator formed by a rear mirror 25a and an output coupler (OC) 25b, a charger 23, and a pulsed power module (PPM) 22. The optical resonator in Comparative Example is a Fabry-Perot resonator.

The chamber 21 is provided with windows 21a and 21b. A laser gas has been encapsulated as a laser medium in the chamber 21.

The chamber 21 has an opening formed therein, and is provided with an electrically insulating plate 26, in which multiple feedthroughs 26a are embedded, so as to close the opening. The PPM 22 is disposed on the electrically insulating plate 26. A pair of discharge electrodes 27a and 27b as main electrodes and a ground plate 28 are disposed in the chamber 21. A discharge surface of each of the discharge electrodes 27a and 27b has a rectangular shape.

The discharge electrodes 27a and 27b are so disposed that the discharge surfaces thereof face each other to excite the laser medium through the discharge. The surface of the discharge electrode 27a that is opposite to the discharge surface is supported by the electrically insulating plate 26. The discharge electrode 27a is connected to the feedthroughs 26a. The surface of the discharge electrode 27b that is opposite to the discharge surface is supported by the ground plate 28.

The PPM 22 includes a switch 22a and the following components: a charging capacitor; a pulse transformer; a magnetism compression circuit; and a peaking capacitor, none of which is shown. The peaking capacitor is connected to the feedthroughs 26a via a connection portion that is not shown. The charger 23 charges the charging capacitor based on control performed by the laser processor 38.

The on/off state of the switch 22a is controlled by the laser processor 38. The laser processor 38 turns on the switch 22a in response to the light emission trigger signal Tr transmitted from the laser processing processor 40.

When the switch 22a is turned on, a current flows from the charging capacitor to the primary side of the pulse transformer, and the resultant electromagnetic induction causes a current in the opposite direction to flow to the secondary side of the pulse transformer. The magnetism compression circuit is connected to the secondary side of the pulse transformer and compresses the pulse width of each current pulse. The peaking capacitor is charged by the current pulses. When the voltage across the peaking capacitor reaches the breakdown voltage of the laser gas, dielectric breakdown occurs in the laser gas between the discharge electrodes 27a and 27b, resulting in the discharge. The discharge generates one pulse of the laser light Lb.

The rear mirror 25a is formed by coating a flat substrate with a highly reflective film. The output coupler 25b is formed by coating a flat substrate with a partially reflective film. The chamber 21 is disposed between the rear mirror 25a and the output coupler 25b. The laser light Lb generated in the chamber 21 is amplified by the optical resonator and output via the output coupler 25b.

The monitor module 30 includes a beam splitter 31, a light collecting lens 32, and a photosensor 33. The beam splitter 31 is disposed in the optical path of the laser light Lb output via the output coupler 25b and reflects part of the laser light Lb. The light collecting lens 32 is disposed in the optical path of the laser light Lb reflected off the beam splitter 31, collects the laser light Lb, and causes the collected laser light Lb to be incident on the photosensor 33. The photosensor 33 measures the pulse energy of the laser light Lb and transmits the measured value to the laser processor 38.

The laser processor 38 controls the pulse energy of the laser light Lb output from the laser apparatus 2 by changing a charging voltage applied to the charger 23 based on the value of the pulse energy measured with the photosensor 33 in such a way that the pulse energy becomes the target pulse energy Et.

The shutter 35 is disposed in the optical path of the laser light Lb having passed through the beam splitter 31. The shutter 35 opens and closes in response to instructions from the laser processor 38. The laser processor 38 controls the output of the laser light Lb output from the laser apparatus 2 by controlling the shutter 35.

FIG. 3 schematically shows the beam shape of the laser light Lb taken along a VH plane along the line A-A shown in FIG. 2. The beam has a rectangular shape longer in the V direction than in the H direction.

### 2.2 Operation

The operation of the laser processing system 1 according to Comparative Example will next be described. The laser processing processor 40 first controls the moving stage 43 in such a way that the back focal position of the imaging optical system 64 coincides with the surface 45a of the workpiece 45.

The laser processing processor 40 then transmits the target pulse energy Et to the laser apparatus 2 in such a way that the fluence of the laser light Lb radiated onto the surface 45a of the workpiece 45 becomes target fluence Ft, and also controls transmittance Ta of the attenuator 47. The fluence used herein refers to the energy density of the laser light Lb radiated to a certain position. The target fluence Ft is fluence optimum for processing that requires fluence exceeding an ablation threshold at the surface 45a of the workpiece 45.

The target fluence Ft is expressed by an expression Ft=Et×Ta×To/S. In the expression, To represents the transmittance of the entire optical system excluding the attenuator 47 in the optical apparatus 41. Let T1 be the transmittance of the highly reflective mirrors 46a and 46b, T2 be the transmittance of the illumination optical system 50, T3 be the transmittance of the mask 48, and T4 be the transmittance of the projection optical system 60, and an expression To=T1×T2×T3×T4 is satisfied. S represents an irradiation area of the surface 45a irradiated with the laser light Lb. The irradiation area S is expressed by an expression S=π(D/2)². In the expression, D represents the beam spot diameter of the laser light Lb.

Having received the target pulse energy Et, the laser processor 38 closes the shutter 35 and sets the charging voltage in the charger 23 in accordance with the target pulse energy Et. The laser processor 38 inputs a trigger to the switch 22a of the PPM 22 in response to an internal trigger that is not shown. As a result, the oscillator 20 performs spontaneous oscillation.

The laser light Lb output from the oscillator 20 is sampled by the monitor module 30, which then measures the pulse energy of the laser light Lb. The laser processor 38 controls the charging voltage applied to the charger 23 in such a way that a difference ΔE between the measured pulse energy and the target pulse energy Et approaches zero.

When the difference ΔE falls within an allowable range, the laser processor 38 transmits a permission signal to the laser processing processor 40 to open the shutter 35. Upon reception of the permission signal, the laser processing processor 40 transmits the light emission trigger signal Tr instructing a predetermined number of pulses N to the laser apparatus 2 at a predetermined repetition frequency f. As a result, the laser light Lb having passed through the beam splitter 31 of the monitor module 30 enters the optical apparatus 41 of the laser processing apparatus 4 in synchronization with the light emission trigger signal Tr.

The laser light Lb having entered the optical apparatus 41 passes through the attenuator 47 via the highly reflective mirrors 46a and 46b, and enters the illumination optical system 50. The beam diameter of the laser light Lb having entered the illumination optical system 50 is increased by the beam expander 51. The laser light Lb having the increased beam diameter is reflected off the highly reflective mirror 52, is focused by the light focusing optical system 57, and illuminates the mask 48.

The laser light Lb having passed through the mask 48 enters the projection optical system 60. The laser light Lb having entered the projection optical system 60 is collimated by the collimation optical system 66 and incident on the diaphragm 63. The laser light Lb having passed through the opening 63a of the diaphragm 63 is brought into focus at the surface 45a of the workpiece 45 by the imaging optical system 64, and forms an image representing the shape of the opening 48a.

Repeatedly irradiating the workpiece 45 with the laser light Lb causes ablation to occur at the workpiece 45, and drilling is performed.

### 2.3 Problems

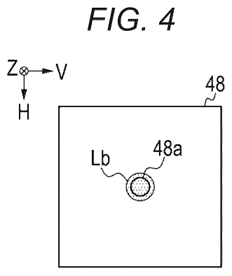

Problems with the laser processing apparatus 4 according to Comparative Example will next be described. FIG. 4 schematically shows the shape of the laser light Lb radiated to the mask 48. The laser light Lb is radiated to be large enough to fill the opening 48a.

The laser processing apparatus 4 focuses the laser light Lb and radiates the focused laser light Lb onto the mask 48 to increase the utilization efficiency of the laser light Lb incident from the laser apparatus 2, so that fluence Fm on the mask 48 increases. When the fluence Fm is high, the image formed at the surface 45a of the workpiece 45 may be deformed because a portion of the mask 48 that is around the opening 48a and blocks the laser light Lb is damaged so that the shape of the opening 48a is distorted. Focusing the laser light Lb and radiating the focused laser light Lb onto the mask 48 as described above shortens the life of the mask 48 against the laser pulses.

For example, when drilling is performed on the workpiece 45 made of glass or a ceramic material, it is necessary to set high target fluence Ft, so that the fluence Fm approaches a damage threshold, and the life of the mask 48 against laser pulses may further decrease. The damage threshold is, for example, 1 J/cm².

The fluence Fm is expressed by an expression Fm=Ft×Mg²/T4. In the expression, Mg represents the projection magnification of the projection optical system 60. For example, when Ft=25 J/cm², Mg=⅕, and T4=90%, the fluence Fm becomes 1.1 J/cm², which exceeds the damage threshold.

In view of the circumstances described above, the present disclosure provides a laser processing apparatus that prolongs the life of a mask against laser pulses.

### 3. First Embodiment

A laser processing system 1 according to a first embodiment of the present disclosure will be described. Note that the same components as those described above have the same reference characters, and duplicate description of the same components will be omitted unless otherwise particularly described.

### 3.1 Configuration

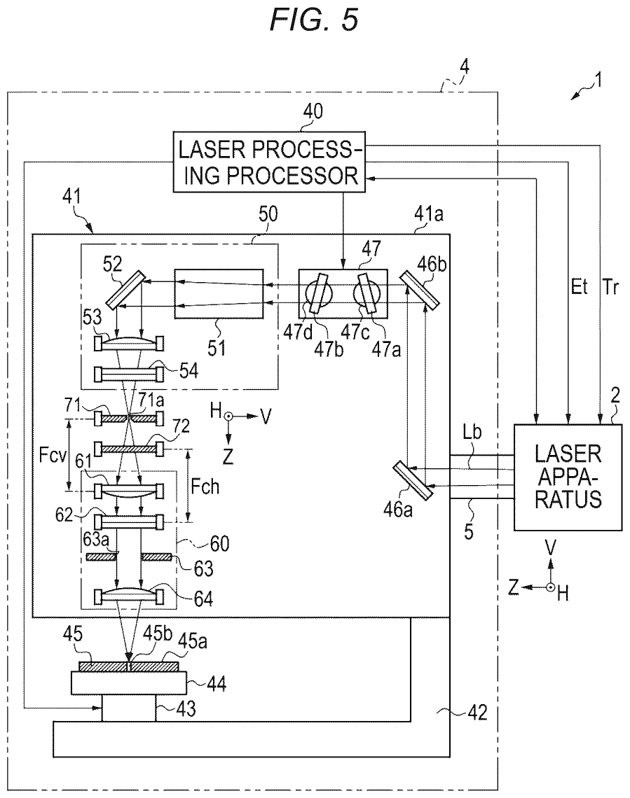

FIG. 5 schematically shows the configuration of the laser processing system 1 according to the first embodiment. The laser processing system 1 differs from the laser processing system 1 according to Comparative Example only in the configuration of the optical apparatus 41.

In the present embodiment, the illumination optical system 50 includes a first light focusing optical system 53 and a second light focusing optical system 54 in place of the light focusing optical system 57. The first light focusing optical system 53 and the second light focusing optical system 54 are sequentially disposed in the optical path of the laser light Lb reflected off the highly reflective mirror 52. Note that the arrangement order of the first light focusing optical system 53 and the second light focusing optical system 54 may be reversed.

The first light focusing optical system 53 and the second light focusing optical system 54 are each a cylindrical convex lens having optical power in only one direction. The first light focusing optical system 53 has optical power in the V direction, and focuses the laser light Lb in the V direction in such a way that the laser light Lb has a linear shape extending in the H direction at the beam waist position of the laser light Lb in the V direction. The second light focusing optical system 54 has optical power in the H direction, and focuses the laser light Lb in the H direction in such a way that the laser light Lb has a linear shape extending in the V direction at the beam waist position of the laser light Lb in the H direction.

Hereinafter, the beam waist position in the V direction is referred to as a “first beam waist position”, and the beam waist position in the H direction is referred to as a “second beam waist position”. Furthermore, the linear shape extending in the H direction is referred to as a “first linear shape”, and the linear shape extending in the V direction is referred to as a “second linear shape”. The first beam waist position is an example of the “first position” according to the technology described in the present disclosure. The second beam waist position is an example of the “second position” according to the technology described in the present disclosure.

In present embodiment, in place of the mask 48, a first optical slit 71 and a second optical slit 72 are disposed in the optical path of the laser light Lb output from the illumination optical system 50. The first optical slit 71 has a rectangular opening 71a extending in the H direction. The second optical slit 72 has a rectangular opening 72a extending in the V direction.

In present embodiment, the first optical slit 71 is disposed at the first beam waist position, and the second optical slit 72 is disposed at the second beam waist position. The opening 71a of the first optical slit 71 is illuminated with the laser light Lb having the first linear shape. The opening 72a of the second optical slit 72 is illuminated with the laser light Lb having the second linear shape. Note that the opening 71a and 72a are each not limited to a physical through hole, and may each be a transmissive region that transmits the laser light Lb.

In the present embodiment, the projection optical system 60 includes a first collimation optical system 61 and a second collimation optical system 62 in place of the collimation optical system 66. The first collimation optical system 61 and the second collimation optical system 62 are each a cylindrical convex lens having optical power in only one direction. The first collimation optical system 61 has optical power in the V direction, and collimates the laser light Lb having passed through the first optical slit 71 in the V direction. The second collimation optical system 62 has optical power in the H direction, and collimates the laser light Lb having passed through the second optical slit 72 in the H direction.

The first collimation optical system 61 is so disposed that the first optical slit 71 is located at the front focal position of the first collimation optical system 61. The second collimation optical system 62 is so disposed that the second optical slit 72 is located at the front focal position of the second collimation optical system 62. It is preferable that a focal length Fcv of the first collimation optical system 61 and a focal length Fch of the second collimation optical system 62 be equal to each other.

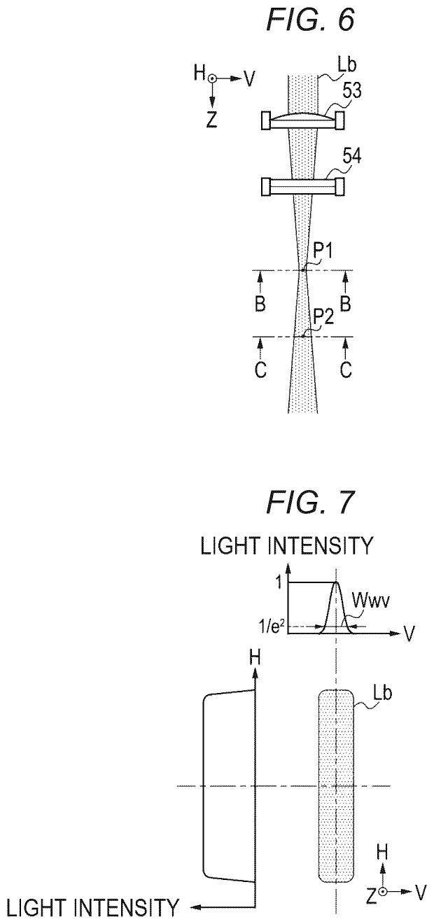

FIG. 6 shows a first beam waist position P1 and a second beam waist position P2. FIG. 7 schematically shows the beam shape of the laser light Lb taken along a VH plane along the line B-B shown in FIG. 6. FIG. 8 schematically shows the beam shape of the laser light Lb taken along a VH plane along the line C-C shown in FIG. 6. That is, FIG. 7 shows the light intensity distribution of the laser light Lb having the first linear shape at the first beam waist position P1, and FIG. 8 shows the light intensity distribution of the laser light Lb having the second linear shape at the second beam waist position P2.

In FIG. 7, Wwv represents the full width of the beam waist in the V direction. The beam waist full width Wwv is a beam width at which the light intensity is 1/e² times the maximum value at the first beam waist position P1. In FIG. 8, Wwh represents the full width of the beam waist in the H direction. The beam waist full width Wwh is a beam width at which the light intensity is 1/e² times the maximum value at the second beam waist position P2.

The beam waist positions each do not necessarily coincide with the back focal position of the corresponding light focusing optical system. Since the laser apparatus 2 is a discharge-excitation-type laser apparatus, the first beam waist position P1 may be downstream from the back focal position of the first light focusing optical system 53, and the second beam waist position P2 may be downstream from the back focal position of the second light focusing optical system 54. In particular, since the second beam waist position P2 is downstream from the back focal position of the second light focusing optical system 54, it is preferable to place the second light focusing optical system 54 further upstream than a position separate from the second beam waist position P2 upstream by the focal length of the second light focusing optical system 54.

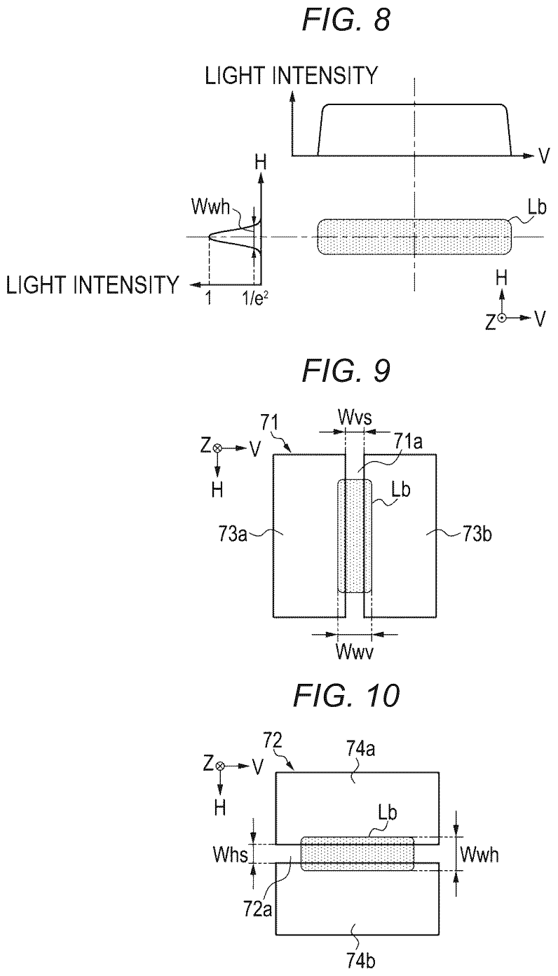

FIG. 9 schematically shows the configuration of the first optical slit 71. The first optical slit 71 includes a pair of blades 73a and 73b. The opening 71a is formed by the pair of blades 73a and 73b separate from each other in the V direction. The blades 73a and 73b are preferably made, for example, of a high-melting-point metal such as tungsten (W), molybdenum (Mo), or tantalum (Ta), or even diamond, diamond-like carbon, or the like.

Let Wvs be the width of the opening 71a in the V direction, and an expression Wvs<Wwv is satisfied. The laser light Lb illuminates the first optical slit 71 so as to be larger than the opening 71a in the V direction. The width Wvs will be hereinafter referred to as a “first slit width Wvs”.

FIG. 10 schematically shows the configuration of the second optical slit 72. The second optical slit 72 includes a pair of blades 74a and 74b. The opening 72a is formed by the pair of blades 74a and 74b separate from each other in the H direction. The blades 74 and 74b are preferably made, for example, of a high-melting-point metal such as tungsten, molybdenum, or tantalum, or even diamond, diamond-like carbon, or the like.

Let Whs be the width of the opening 72a in the H direction, and an expression Whs<Wwh is satisfied. The laser light Lb illuminates the second optical slit 72 so as to be larger than the opening 72a in the H direction. The width Whs will be hereinafter referred to as a “second slit width Whs”.

### 3.2 Operation

The operation of the laser processing system 1 according to the first embodiment will next be described. The operation of the laser processing system 1 according to the present embodiment differs from that in Comparative Example only in the actions in the optical apparatus 41. Only the points different from those in Comparative Example will be described below.

The beam diameter of the laser light Lb having entered the illumination optical system 50 is increased by the beam expander 51. The laser light Lb having the increased beam diameter is reflected off the highly reflective mirror 52, enters the first light focusing optical system 53, passes through the first light focusing optical system 53, and enters the second light focusing optical system 54. The laser light Lb is focused into the laser light Lb having the first linear shape by the first light focusing optical system 53 and illuminates the first optical slit 71. The laser light Lb is focused into the laser light Lb having the second linear shape by the second light focusing optical system 54 and illuminates the second optical slit 72.

The laser light Lb having passed through the first optical slit 71 and the second optical slit 72 enters the projection optical system 60. The laser light Lb having entered the projection optical system 60 is collimated in the V direction by the first collimation optical system 61, collimated in the H direction by the second collimation optical system 62, and incident on the diaphragm 63. The laser light Lb having passed through the opening 63a of the diaphragm 63 is brought into focus at the surface 45a of the workpiece 45 by the imaging optical system 64.

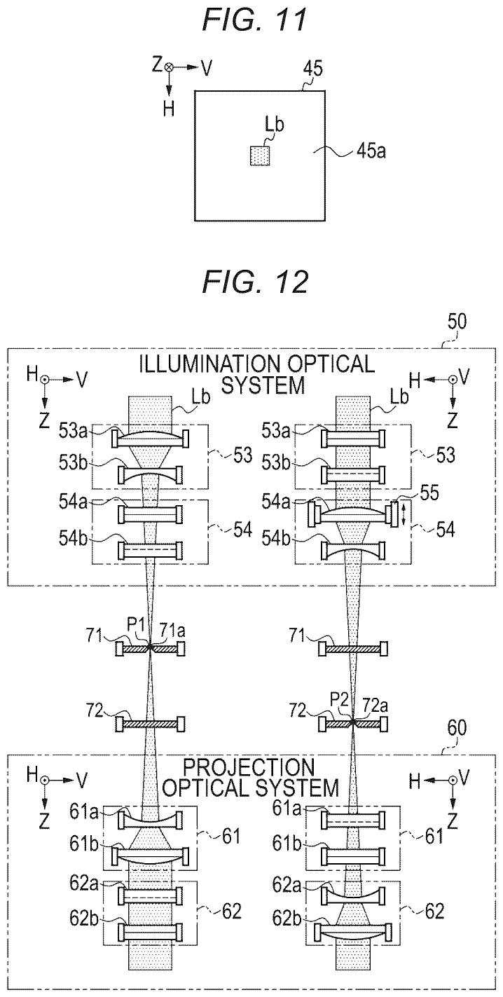

A rectangular image of the laser light Lb representing the shape of the portion where the opening 71a of the first optical slit 71 and the opening 72a of the second optical slit 72 overlap with each other is formed at the surface 45a of the workpiece 45, as shown in FIG. 11. Repeatedly irradiating the workpiece 45 with the laser light Lb causes ablation to occur at the workpiece 45, and drilling is performed.

### 3.3 Effects

In the present embodiment, the first optical slit 71 is illuminated with the laser light Lb focused in the V direction by the first light focusing optical system 53 and having the first linear shape, and the second optical slit 72 is illuminated with the laser light Lb focused in the H direction by the second light focusing optical system 54 and having the second linear shape. The fluence of the laser light Lb with which the first optical slit 71 and the second optical slit 72 are each illuminated is therefore lower than the fluence of the laser light Lb with which the mask 48 is illuminated in Comparative Example. As a result, damage to the first optical slit 71 and the second optical slit 72 is suppressed, so that a laser processing apparatus 4 that provides a long life against laser pulses can be provided.

Furthermore, in the present embodiment, the first optical slit 71 is disposed at the first beam waist position P1, and the second optical slit 72 is disposed at the second beam waist position P2, so that the laser light Lb can efficiently pass therethrough.

### 4. Variations of First Embodiment

A variety of variations of the first embodiment will next be described.

### 4.1 First Variation

A first variation differs from the first embodiment only in the configurations of the illumination optical system 50 and the projection optical system 60.

### 4.1.1 Configuration

FIG. 12 partially shows the configurations of an illumination optical system 50 and a projection optical system 60 according to the first variation. FIG. 12 shows the configuration viewed in the H direction and the configuration viewed in the V direction.

In the present variation, the first light focusing optical system 53 is a unit lens that is the combination of a cylindrical convex lens 53a and a cylindrical concave lens 53b. The cylindrical convex lens 53a and the cylindrical concave lens 53b each have optical power in the V direction, and focus the laser light Lb in the V direction to form the first linear shape.

In the present variation, the second light focusing optical system 54 is a unit lens that is the combination of a cylindrical convex lens 54a and a cylindrical concave lens 54b. The cylindrical convex lens 54a and the cylindrical concave lens 54b each have optical power in the H direction, and focus the laser light Lb in the H direction to form the second linear shape.

Furthermore, the second light focusing optical system 54 is provided with an actuator 55, which can change the distance between the cylindrical convex lens 54a and the cylindrical concave lens 54b. The actuator 55 is, for example, a uniaxial moving stage. The actuator 55 is controlled by the laser processing processor 40. In the present variation, the actuator 55 moves the cylindrical convex lens 54a. Note that the actuator 55 may move the cylindrical concave lens 54b.

In the present variation, the first collimation optical system 61 is a unit lens that is the combination of a cylindrical concave lens 61a and a cylindrical convex lens 61b. The cylindrical concave lens 61a and the cylindrical convex lens 61b each have optical power in the V direction, and collimates in the V direction the laser light Lb having passed through the first optical slit 71.

In the present variation, the second collimation optical system 62 is a unit lens that is the combination of a cylindrical concave lens 62a and a cylindrical convex lens 62b. The cylindrical concave lens 62a and the cylindrical convex lens 62b each have optical power in the H direction, and collimates in the H direction the laser light Lb having passed through the second optical slit 72.

### 4.1.2 Operation

The operation of the laser processing system 1 according to the present variation is the same as that in the first embodiment, and will therefore not be described.

### 4.1.3 Effects

In the present variation, since plural unit lenses constitute the illumination optical system 50 and the projection optical system 60, the distance from the illumination optical system 50 to the workpiece 45 can be shortened. The configuration described above is advantageous when an illumination optical system 50 having a small numerical aperture is used.

Table 1 shows an example of the specifications of the illumination optical system 50 and the projection optical system 60 for drilling a hole having a large aspect ratio in a glass substrate for an interposer.

TABLE 1

| fi (mm) | NAi | Mg | NAo | fo (mm) | NAil |
|---|---|---|---|---|---|
| 100 | 0.03 | 1/30 | 0.001 | 3000 | 0.001 |
| 100 | 0.04 | 1/10 | 0.004 | 1000 | 0.004 |
| 100 | 0.05 | 1/25 | 0.002 | 2500 | 0.002 |
| 100 | 0.06 | 1/15 | 0.004 | 1500 | 0.004 |

In Table 1, fi represents the focal length of the imaging optical system 64, NAi represents the numerical aperture of the imaging optical system 64, Mg represents the projection magnification of the projection optical system 60, and NAo represents the numerical aperture of the first collimation optical system 61 and the second collimation optical system 62. Furthermore, fo represents the focal length of the first collimation optical system 61 and the second collimation optical system 62, and NAil represents the numerical aperture of the first light focusing optical system 53 and the second light focusing optical system 54. Note that an expression NAil=NAi×Mg is satisfied.

The numerical aperture NAi falls within the range of 0.03 to 0.06, the projection magnification Mg falls within the range of 1/30 to 1/10, and the numerical apertures NAo and NAil each fall within the range of 0.001 to 0.004, as shown in Table 1. As described above, since the numerical apertures NAo and NAil are very small, and the focal length fo is greater than or equal to 1000 mm, the distance from the illumination optical system 50 to the workpiece 45 is usually longer than or equal to several meters. In the present variation, even when the numerical aperture is small, using multiple unit lenses can shorten the distance from the illumination optical system 50 to the workpiece 45.

Note in the present variation that before the hole drilling operation, the laser processing processor 40 can adjust the second beam waist position P2 by controlling the actuator 55 to change the distance between the cylindrical convex lens 54a and the cylindrical concave lens 54b. The advantage described above is achieved because the second beam waist position P2 is downstream from the back focal position of the second light focusing optical system 54, as described above.

### 4.2 Second Variation

The second variation differs from the first embodiment only in that an optical axis stabilization system for stabilizing the optical axis of the laser light Lb traveling to the illumination optical system 50 is added in the optical apparatus 41.

### 4.2.1 Configuration

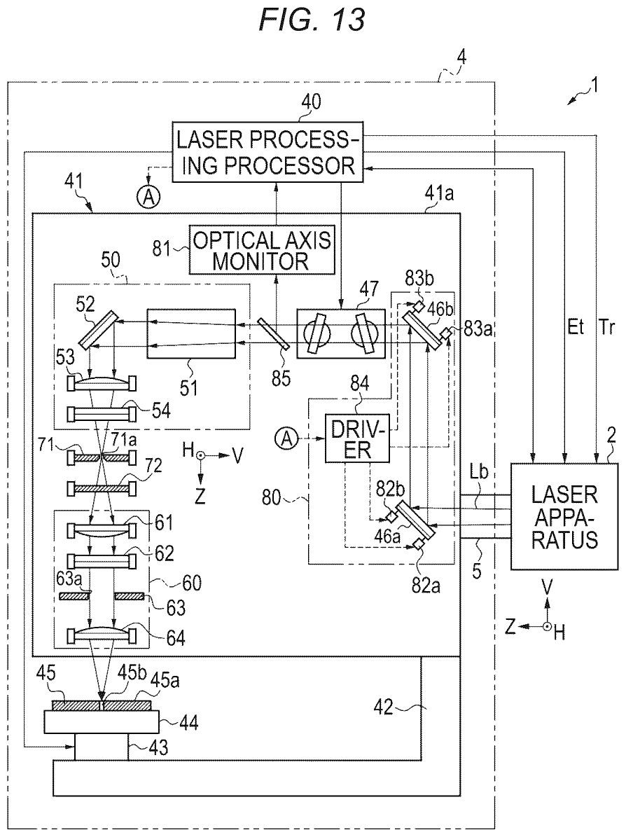

FIG. 13 schematically shows the configuration of a laser processing system 1 according to the second variation. The optical axis stabilization system includes a beam steering apparatus 80, which adjusts the optical axis, and an optical axis monitor 81, which monitors the optical axis.

The beam steering apparatus 80 includes actuators 82a and 82b attached to the highly reflective mirror 46a, actuators 83a and 83b attached to the highly reflective mirror 46b, and a driver 84. The actuators 82a and 82b change the posture of the highly reflective mirror 46a around two axes perpendicular to each other. The actuators 83a and 83b change the posture of the highly reflective mirror 46b around two axes perpendicular to each other. The driver 84 drives the actuators 82a and 82b and the actuators 83a and 83b based on instructions from the laser processing processor 40.

A beam splitter 85 is disposed in the optical path of the laser light Lb between the beam steering apparatus 80 and the illumination optical system 50. The beam splitter 85 reflects part of the laser light Lb output from the beam steering apparatus 80 and causes the reflected laser light Lb to enter the optical axis monitor 81. The optical axis monitor 81 measures the position of the optical axis based on the laser light Lb incident from the beam splitter 85.

### 4.2.2 Operation

The operation of the laser processing system 1 according to the present variation is the same as that in the first embodiment except that the optical axis stabilization operation is performed when the drilling operation is performed.

Before the drilling operation, the laser processing processor 40 measures and stores in advance a target optical axis position where the laser light Lb passes through the first optical slit 71 and the second optical slit 72 at high transmittance. During the drilling operation, the laser processing processor 40 acquires a measured value of the optical axis position from the optical axis monitor 81, and controls the driver 84 to move the highly reflective mirrors 46a and 46b in such a way that the measured value approaches the target position.

### 4.2.3 Effects

In the present variation, performing the optical axis stabilizing operation during the drilling operation can maintain the state in which the laser light Lb passes through the first optical slit 71 and the second optical slit 72 at high transmittance. As a result, the fluence and the imaging state of the laser light Lb at the surface 45a of the workpiece 45 are stabilized, so that a high-quality hole 45b can be processed.

### 4.3 Third Variation

A third variation differs from the first embodiment only in the configuration of the projection optical system 60.

### 4.3.1 Configuration

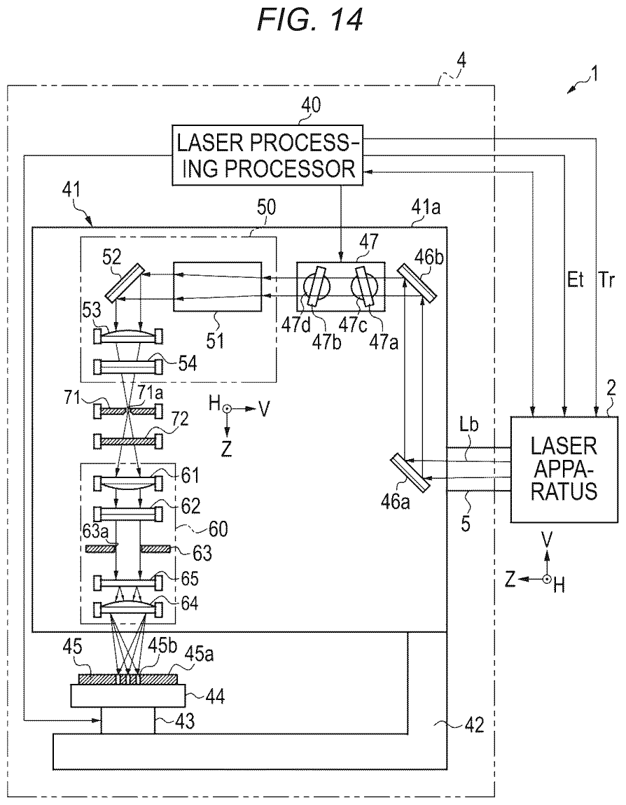

FIG. 14 schematically shows the configuration of a laser processing system 1 according to the third variation. In the present variation, a DOE 65 is disposed in the projection optical system 60 in the optical path of the laser light Lb between the diaphragm 63 and the imaging optical system 64.

### 4.3.2 Operation

The laser processing system 1 according to the present variation differs from that according to the first embodiment only in the actions of the projection optical system 60. In the present variation, the laser light Lb having passed through the opening 63a of the diaphragm 63 is incident on the DOE 65. The DOE 65 divides the incident laser light Lb into multiple beams traveling at different angles, and causes the beams to enter the imaging optical system 64.

The imaging optical system 64 forms images of the multiple beams each representing the shape of the portion where the opening 71a of the first optical slit 71 and the opening 72a of the second optical slit 72 overlap with each other, that is, a multiple point pattern at the surface 45a of the workpiece 45. Repeatedly irradiating the workpiece 45 with the multiple beams, into which the laser light Lb has been divided, causes ablation to occur at the workpiece 45, and multiple holes 45b are simultaneously processed.

### 4.3.3 Effects

In the present variation, using the DOE 65 allows the multiple holes 45b to be simultaneously processed in the workpiece 45.

Using the DOE 65 requires an increase in the fluence at the surface 45a of the workpiece 45 because the laser light Lb is divided into multiple beams. Therefore, when the DOE 65 is used in Comparative Example, the fluence on the mask 48 is high, so that the mask 48 can be easily damaged. In the present variation, the fluence of the laser light Lb with which the first optical slit 71 and the second optical slit 72 are each irradiated is reduced, so that damage thereto is suppressed, as described in the first embodiment. Therefore, in the present variation, the DOE 65 can be used, and the fluence on the surface 45a of the workpiece 45 can be maintained optimally.

Note in the present variation that the DOE 65 is an optical element separate from the imaging optical system 64, and the DOE 65 may instead be an optical element having the function of the imaging optical system 64. That is, the DOE 65 may divide the laser light Lb having passed through the diaphragm 63 into multiple beams, and form images of the multiple beams at the surface 45a of the workpiece 45. In this case, the imaging optical system 64 may not be provided.

### 4.4 Other Variations

In the first embodiment, the image formed at the surface 45a of the workpiece 45 has a rectangular shape that is the shape of the portion where the opening 71a of the first optical slit 71 and the opening 72a of the second optical slit 72 overlap with each other, but it is preferable to make the shape of the image close to a circular shape. There are three manners described below to make the shape of the image closer to a circular shape.

The first manner is a method for adjusting the resolving power of the imaging optical system 64. Let R be the resolving power of the imaging optical system 64, and an expression R=λ/(2×NAi) is satisfied. In the expression, λ represents the wavelength of the laser light Lb. According to the expression, the resolving power R depends on the numerical aperture NAi. For example, making the size of the opening 63a of the diaphragm 63 variable allows a change in the numerical aperture NAi to adjust the resolving power R. Setting the resolving power R to be approximately equal to the diameter of the hole 45b to be processed can make the shape of the image close to a circular shape.

When the resolving power R is smaller than the diameter of the hole 45b to be processed, the shape of the image becomes angular and close to a rectangular shape. In this case, using the second or third manner can make the shape of the image close to a circular shape. In the second manner, the shape of the opening 63a of the diaphragm 63 is changed. In the third manner, the shape of the opening 71a of the first optical slit 71 and the shape of the opening 72a of the second optical slit 72 are changed.

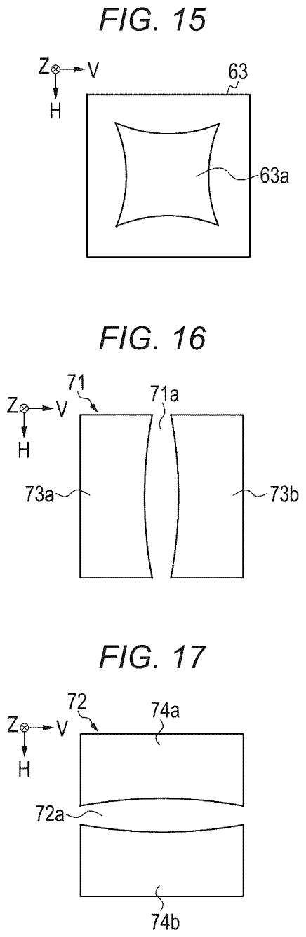

FIG. 15 schematically shows the shape of the opening 63a of the diaphragm 63 that can make the shape of the image close to a circular shape. The opening 63a has the shape of a pincushion that is symmetrical with respect to the V and H directions. The width of the opening 63a is smaller at positions closer to the center thereof in the V and H directions. As described above, using the diaphragm 63 having the pincushion-shaped opening 63a allows the image to be so corrected that the shape thereof becomes close to a circular shape.

FIG. 16 schematically shows the shape of the opening 71a of the first optical slit 71 that can make the shape of the image close to a circular shape. FIG. 17 schematically shows the shape of the opening 72a of the second optical slit 72 that can make the shape of the image close to a circular shape. The openings 71a and 72a each have the shape of a barrel that is symmetrical with respect to the V and H directions. The width of the opening 71a is greater at positions closer to the center thereof in the H direction. The width of the opening 72a is greater at positions closer to the center thereof in the V direction. Using the first optical slit 71 having the barrel-shaped opening 71a and the second optical slit 72 having the barrel-shaped opening 72a allows the image to be so corrected that the shape thereof becomes close to a circular shape.

Using any of the manners described above can make the shape of the processed hole 45b close to a circular shape. Note that any of the manners described above may be applied to the third variation described above. In this case, multiple circular holes 45b can be simultaneously processed.

### 5. Second Embodiment

A laser processing system 1 according to a second embodiment of the present disclosure will be described. Note that the same components as those described above have the same reference characters, and duplicate description of the same components will be omitted unless otherwise particularly described.

### 5.1 Configuration

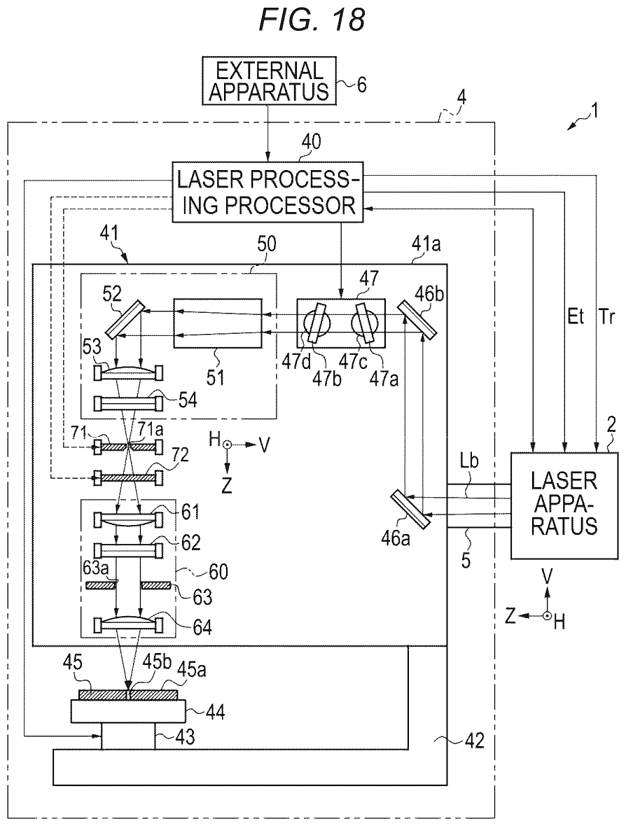

FIG. 18 schematically shows the configuration of a laser processing system 1 according to the second embodiment. The laser processing system 1 differs from the laser processing system 1 according to the first embodiment only in the configuration of the optical apparatus 41.

In the present embodiment, the first optical slit 71 has a variable first slit width Wvs, which is controlled by the laser processing processor 40. In the present embodiment, the second optical slit 72 has a variable second slit width Whs, which is controlled by the laser processing processor 40.

Furthermore, in the present embodiment, the laser processing processor 40 includes an interface for communication with an external apparatus 6. The laser processing processor 40 receives data necessary for drilling from the external apparatus 6. The data contains a target value Dt of the diameter of the hole 45b to be processed, the material of the workpiece 45, and other pieces of information. The external apparatus 6 may be a management system that manages the laser processing apparatus 4 and the like, an input apparatus for inputting drilling processing condition data, or the like.

### 5.2 Operation

The operation of the laser processing system 1 according to the present embodiment differs from that in the first embodiment only in that the operation includes the adjustment operation of adjusting the first slit width Wvs and the second slit width Whs before performing the drilling.

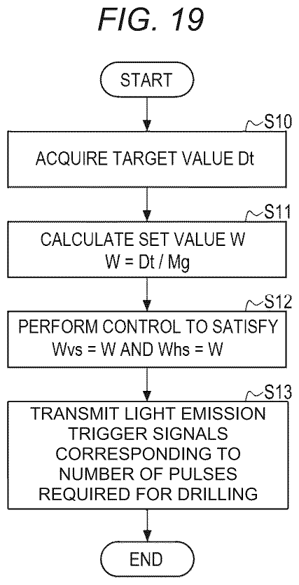

FIG. 19 shows the procedure of the drilling operation according to the second embodiment. Operations similar to those in the first embodiment will not be described.

The laser processing processor 40 first acquires the target value Dt from the external apparatus 6 (step S10). The laser processing processor 40 then calculates a set value W (step S11). For example, the laser processing processor 40 calculates the set value W based on an expression W=Dt/Mg.

The laser processing processor 40 next controls the first optical slit 71 and the second optical slit 72 in such a way that the first slit width Wvs and the second slit width Whs become the set value W (step S12). The laser processing processor 40 then transmits the light emission trigger signals Tr corresponding to the number of pulses required for the drilling to the laser apparatus 2 (step S13). As a result, the workpiece 45 is irradiated with the laser light Lb having a beam diameter equal to the target value Dt, so that the drilling is performed.

### 5.3 Effects

In Comparative Example, changing the diameter of the hole 45b to be processed requires replacement of the mask 48, and replacing the mask 48 requires alignment thereof again, resulting in a decrease in throughput. In the present embodiment, the first slit width Wvs and the second slit width Whs are adjusted in accordance with the target value Dt of the diameter of the hole 45b to be processed without replacing the first optical slit 71 and the second optical slit 72, so that a decrease in throughput can be suppressed.

Note that the diameter of the beam spot radiated onto the surface 45a of the workpiece 45 may not coincide with the diameter of the hole 45b that is actually formed. In this case, the laser processing processor 40 may store a correction coefficient k in advance and calculate the set value W based on an expression W=k×Dt/Mg. The correction coefficient k can be determined by dividing the target value Dt by the diameter of the hole 45b that is actually formed.

Furthermore, the DOE 65 described above may be disposed between the diaphragm 63 and the imaging optical system 64. In this case, multiple holes 45b can be simultaneously processed.

### 6. Variations of Second Embodiment

A variety of variations of the second embodiment will next be described.

### 6.1 First Variation

The first variation differs from the second embodiment only in the configuration of the illumination optical system 50.

### 6.1.1 Configuration

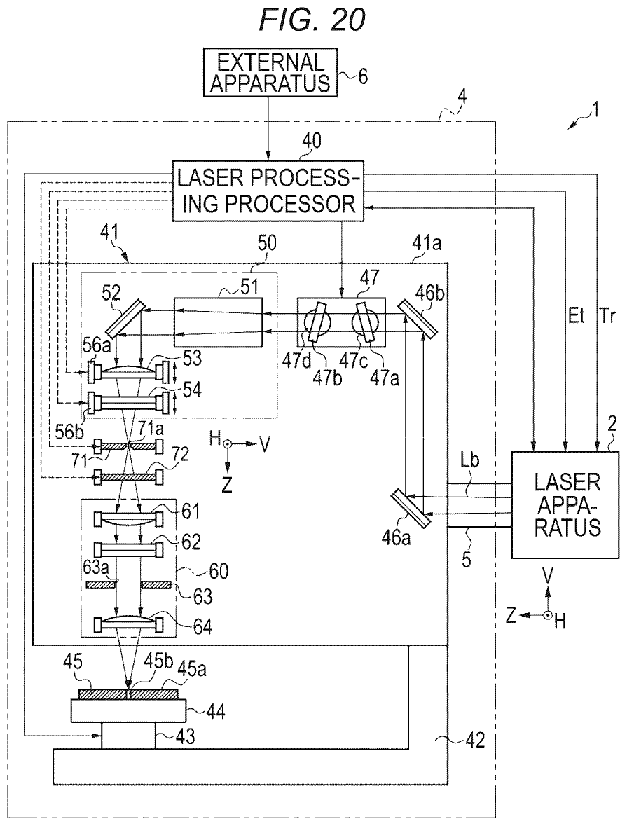

FIG. 20 schematically shows the configuration of a laser processing system 1 according to a first variation. In the present variation, the illumination optical system 50 includes an actuator 56a, which moves the first light focusing optical system 53 in the optical axis direction, and an actuator 56b, which moves the second light focusing optical system 54 in the optical axis direction. For example, the actuators 56a and 56b are each a uniaxial moving stage. The actuators 56a and 56b are controlled by the laser processing processor 40. The actuator 56a is an example of the “first actuator” according to the technology described in the present disclosure. The actuator 56b is an example of the “second actuator” according to the technology described in the present disclosure.

### 6.1.2 Operation

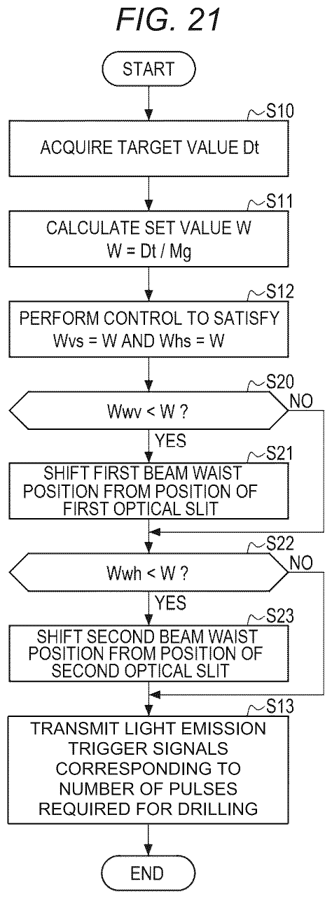

FIG. 21 shows the procedure of the drilling operation according to the first variation. The drilling operation according to the present variation differs from the drilling operation according to the second embodiment only in that steps S20 to S23 are added between step S12 and step S13.

In the present variation, after step S12, the laser processing processor 40 evaluates whether the beam waist full width Wwv in the V direction is smaller than the set value W (step S20). When Wwv≥W (NO in step S20), the laser processing processor 40 transitions to the process in step S22.

When Wwv≤W (YES in step S20), the laser processing processor 40 shifts the first beam waist position P1 from the position of the first optical slit 71 by controlling the actuator 56a to move the first light focusing optical system 53 in the optical axis direction (step S21). Specifically, the laser light Lb with which the first optical slit 71 is illuminated is so defocused that the beam spot diameter of the laser light Lb in the V direction becomes greater than the set value W. It is preferable that the laser processing processor 40 moves the first light focusing optical system 53 upstream in such a way that the first beam waist position P1 is upstream from the position of the first optical slit 71.

The laser processing processor 40 next evaluates whether the beam waist full width Wwh in the H direction is smaller than the set value W (step S22). When Wwh≥W (NO in step S22), the laser processing processor 40 transitions to the process in step S13.

When Wwh<W (YES in step S22), the laser processing processor 40 shifts the second beam waist position P2 from the position of the second optical slit 72 by controlling the actuator 56b to move the second light focusing optical system 54 in the optical axis direction (step S23). Specifically, the laser light Lb with which the second optical slit 72 is illuminated is so defocused that the beam spot diameter of the laser light Lb in the H direction becomes greater than the set value W. It is preferable that the laser processing processor 40 moves the second light focusing optical system 54 upstream in such a way that the second beam waist position P2 is upstream from the position of the second optical slit 72.

### 6.1.3 Effects

In the second embodiment, the diameter of the hole 45b to be processed cannot be made greater than the value determined by the full width of the beam waist. In the present variation, shifting the beam waist position for defocusing allows the diameter of the hole 45b to be processed to be made greater than the value determined by the full width of the beam waist.

Note that the laser processing processor 40 may store in advance the beam waist full widths Wwv and Wwh used in the evaluation in steps S20 and S22. The laser processing processor 40 may instead calculate the beam waist full widths Wwv and Wwh used in the evaluation in steps S20 and S22 by using Expressions (1) and (2) below.

$$Wwv = ( 2 / π ) \times ( λ / NAv ) \times M {v}^{2} \qquad ( 1 )$$

$$Wwh = ( 2 / π ) \times ( λ / NAh ) \times M {h}^{2} \qquad ( 2 )$$

In Expression (1), NAv represents the numerical aperture of the first light focusing optical system 53, and Mv² represents an M square value that is the square of the value M in the V direction. In Expression (2), NAh represents the numerical aperture of the second light focusing optical system 54, and Mh² represents an M square value in the H direction. The squares of the values M, Mv² and Mh², may be measured values measured in advance.

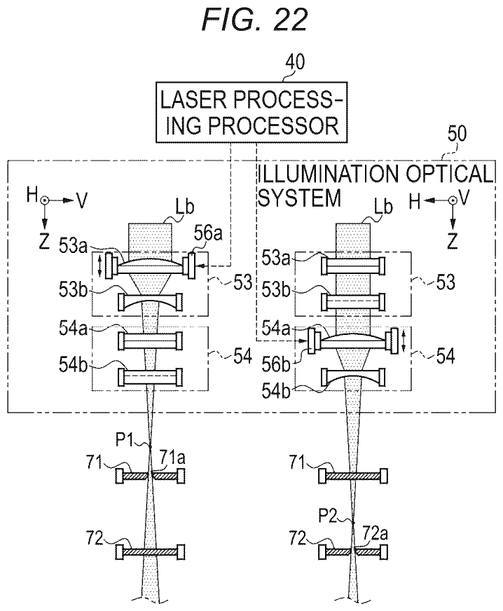

Moreover, as in the first variation of the first embodiment, the first light focusing optical system 53 and the second light focusing optical system 54 may each be a unit lens, as shown in FIG. 22. Although not shown in FIG. 22, the first collimation optical system 61 and the second collimation optical system 62 may each be a unit lens. In this case, for example, it is preferable to provide the cylindrical convex lens 53a with the actuator 56a and the cylindrical convex lens 54a with the actuator 56b.

The laser processing processor 40 moves the first beam waist position P1 by controlling the actuator 56a to move the cylindrical convex lens 53a in the optical axis direction. The laser processing processor 40 further moves the second beam waist position P2 by controlling the actuator 56b to move the cylindrical convex lens 54a in the optical axis direction.

### 6.2 Second Variation

A second variation differs from the second embodiment only in the configuration of the illumination optical system 50.

### 6.2.1 Configuration

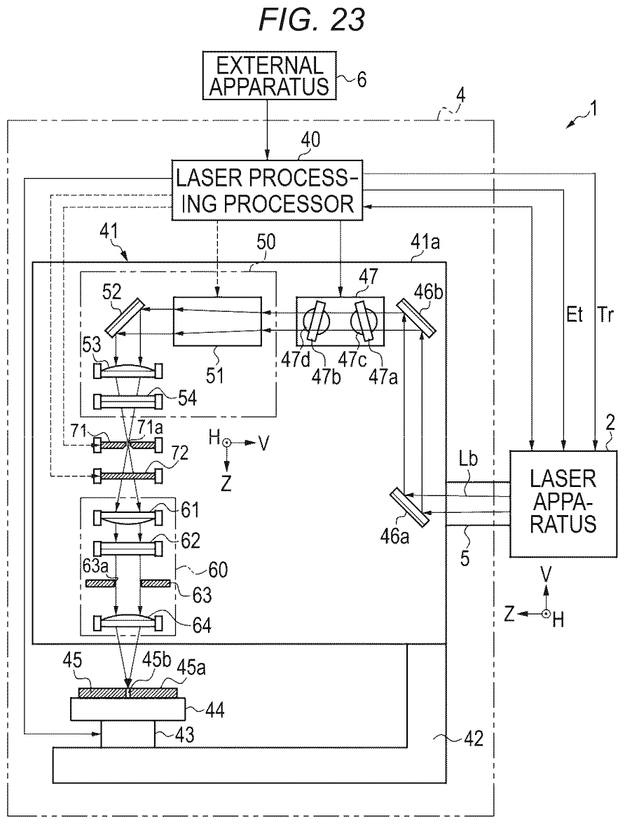

FIG. 23 schematically shows the configuration of a laser processing system 1 according to the second variation. In the present variation, the beam expander 51 has a variable magnification. The magnification of the beam expander 51 is controlled by the laser processing processor 40.

### 6.2.2. Operation

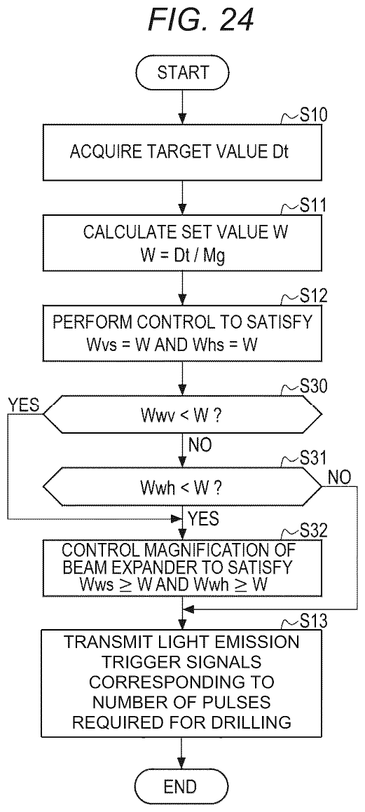

FIG. 24 shows the procedure of the drilling operation according to the second variation. The drilling operation according to the present variation differs from the drilling operation according to the second embodiment only in that steps S30 to S32 are added between step S12 and step S13.

In the present variation, after step S12, the laser processing processor 40 evaluates whether the beam waist full width Wwv in the V direction is smaller than the set value W (step S30). When Wwv≤W (YES in step S30), the laser processing processor 40 transitions to the process in step S32.

When Wwv≥W (NO in step S30), the laser processing processor 40 evaluates whether the beam waist full width Wwh in the H direction is smaller than the set value W (step S31). When Wwh≥W (NO in step S31), the laser processing processor 40 transitions to the process in step S13.

When Wwh<W (YES in step S31), the laser processing processor 40 controls the magnification of the beam expander 51 in such a way that Wwv≥W and Wwh≥W are satisfied (step S32). The numerical apertures NAv and NAh change depending on the magnification of the beam expander 51. Expressions (1) and (2) described above therefore show that the beam waist full widths Wwv and Wwh can be changed by controlling the magnification of the beam expander 51.

### 6.2.3 Effects

In the present variation, controlling the magnification of the beam expander 51 to increase the beam waist total width allows the diameter of the hole 45b to be processed to be made greater than the value determined by the initial full width of the beam waist.

Note that the laser processing processor 40 may store in advance the beam waist full widths Wwv and Wwh used in the evaluation in steps S30 and S31. The laser processing processor 40 may instead calculate the beam waist full widths Wwv and Wwh used in the evaluation in steps S30 and S31 by using Expressions (1) and (2) described above.

Since the numerical apertures NAv and NAh change depending on the magnification of the beam expander 51, the laser processing processor 40 can calculate the beam waist full widths Wwv and Wwh after a change in the magnification of the beam expander 51 by using Expressions (1) and (2) described above. Specifically, substituting the numerical apertures NAv and NAh according to the magnification of the beam expander 51 into Expressions (1) and (2) described above allows calculation of the beam waist full widths Wwv and Wwh.

### 7. Variation of Laser Apparatus

A variation of the laser apparatus 2 will next be described. The laser apparatus 2 shown in FIG. 2 uses a Fabry-Perot resonator as the optical resonator. The laser apparatus 2 according to the present variation includes an unstable resonator in place of the Fabry-Perot resonator.

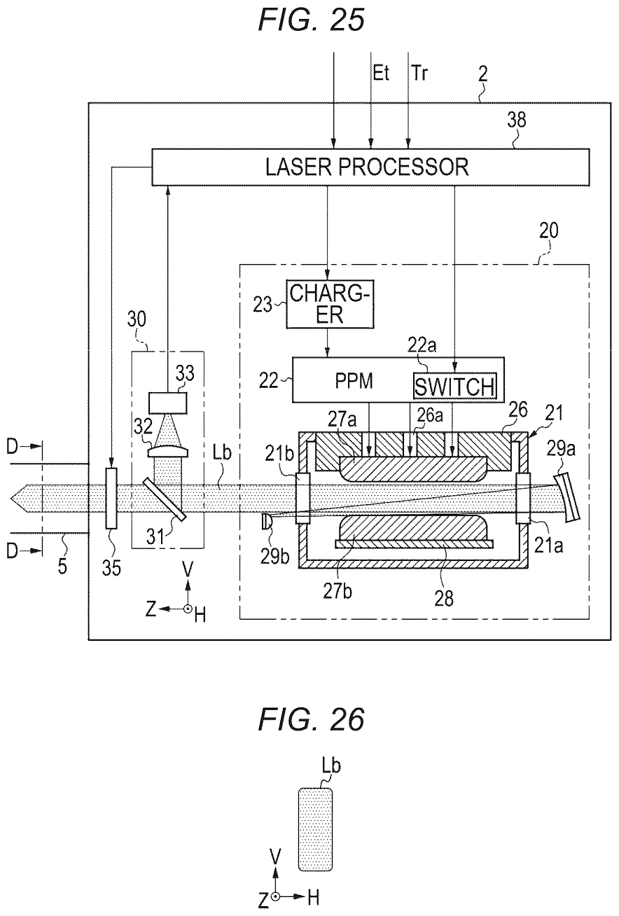

FIG. 25 schematically shows the configuration of the laser apparatus 2 according to the variation. In the present variation, the rear mirror 25a and the output coupler 25b are replaced with a cylindrical concave mirror 29a and a cylindrical convex mirror 29b.

The concave mirror 29a is disposed on the rear side of the chamber 21. The convex mirror 29b is disposed on the front side of the chamber 21. The concave mirror 29a and the convex mirror 29b have the same focal axis, and each increase the beam diameter in the V direction. The expansion factor by which the mirrors expand the laser light Lb ranges from 5 times to 15 times. The concave mirror 29a and the convex mirror 29b constitute an unstable resonator that is unstable only in the V direction.

The laser light Lb output from the laser apparatus 2 according to the present variation has a small number of spatial transverse modes in the V direction, and a small M square value Mv² in the V direction. Setting the expansion factor in the V direction at an appropriate value allows the M square value Mv² in the V direction and the M square value Mh² in the H direction to substantially coincide with each other. For example, it is preferable that the expansion factor in the V direction falls within a range from 10 times to 13 times.

FIG. 26 schematically shows the beam shape of the laser light Lb taken along a VH plane along the line D-D shown in FIG. 25. The beam has a rectangular shape longer in the V direction than in the H direction.

Using the unstable resonator can make the number of spatial transverse modes in the V direction close to the number of spatial transverse modes in the H direction. As a result, the diameter of the hole 45b to be processed can be made smaller than that achieved when a Fabry-Perot resonator is used, and the drilling can be efficiently performed. Using the unstable resonator further allows suppression of resonator loss, and can produce an output comparable to that produced when a Fabry-Perot resonator is used.

Note that the concave mirror 29a and the convex mirror 29b may each have a spherical shape, and the optical resonator may be an unstable resonator that is unstable in the V and H directions. In this case, it is preferable to arrange the concave mirror 29a and the convex mirror 29b in such a way that the focal positions thereof coincide with each other. It is further preferable that the expansion factor falls within the range from 5 times to 10 times. In this case, since the unstable resonator increases the beam diameter in the V and H directions, both the M square value Mv² in the V direction and the M square value Mh² in the H direction can be reduced.

### 8. Beam Expander

A specific configuration of the beam expander 51 will next be described.

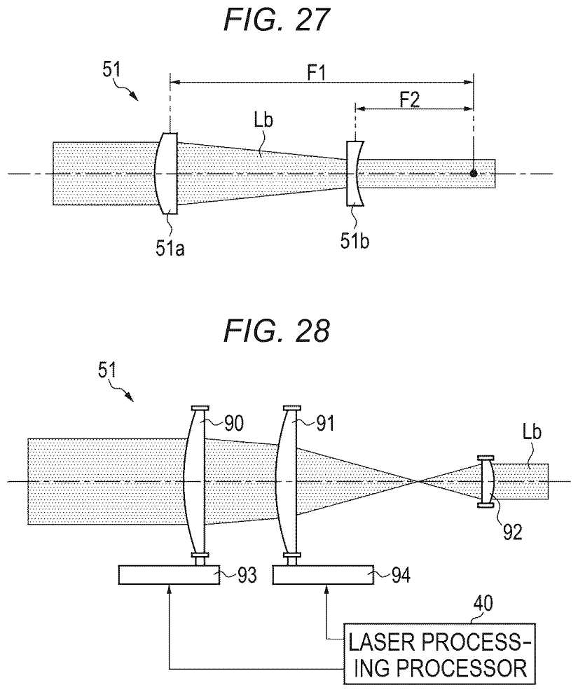

FIG. 27 schematically shows the configuration of the fixed-magnification beam expander 51. The fixed-magnification beam expander 51 includes a unit lens that is the combination of a spherical convex lens 51a and a spherical concave lens 51b. The convex lens 51a and the concave lens 51b are so disposed along the optical axis that the focal positions of the lenses coincide with each other. Let F1 be the focal length of the convex lens 51a, and F2 be the focal length of the concave lens 51b, and a magnification Mbm is expressed by an expression Mbm=F1/F2.

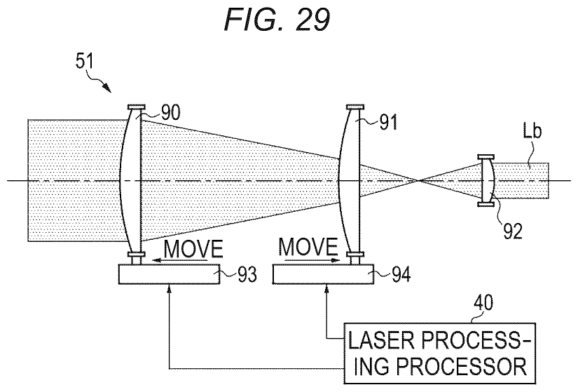

FIGS. 28 and 29 schematically show the configuration of a variable-magnification beam expander 51. The variable-magnification beam expander 51 includes spherical convex lenses 90 to 92 and actuators 93 and 94. The convex lenses 90 to 92 are arranged along the optical axis. The actuators 93 and 94 move the convex lenses 90 and 91 in the optical axis direction, respectively. For example, the actuators 93 and 94 are each a uniaxial moving stage, and are controlled by the laser processing processor 40.

FIG. 28 shows a low magnification state, and FIG. 29 shows a high magnification state. The laser processing processor 40 can change the magnification of the beam expander 51 by controlling the actuators 93 and 94 to move the convex lenses 90 and 91.

Note that a beam expander having a magnification variable in the V direction and a beam expander having a magnification variable in the H direction may instead be arranged along the optical axis. In this case, the magnification in the V direction and the magnification in the H direction can be individually controlled.

### 9. Optical Axis Monitor

A specific configuration of the optical axis monitor 81 will next be described.

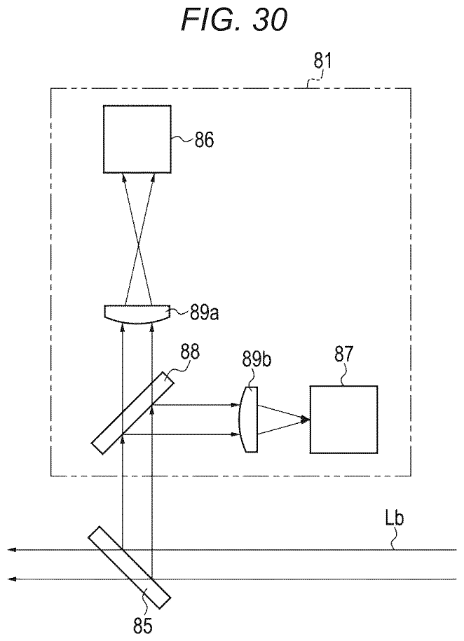

FIG. 30 schematically shows the configuration of the optical axis monitor 81. The optical axis monitor 81 includes a first beam profiler 86, a second beam profiler 87, a beam splitter 88, a transfer lens 89a, and a focusing lens 89b. The beam splitter 88 is disposed in the optical path of the laser light Lb reflected off the beam splitter 85 shown in the second variation of the first embodiment.

The transfer lens 89a is disposed in the optical path of the laser light Lb having passed through the beam splitter 88, and transfers the incident laser light Lb to the first beam profiler 86. The first beam profiler 86 measures the position of the cross-sectional intensity profile of the laser light Lb.

The focusing lens 89b is disposed in the optical path of the laser light Lb reflected off the beam splitter 88, and focuses the incident laser light Lb at the second beam profiler 87. The second beam profiler 87 measures the center position of the point where the laser light Lb is focused.

The optical axis of the laser light Lb can be measured from the position of the cross-sectional intensity profile measured by the first beam profiler 86 and the center position of the point where the laser light Lb is focused measured by the second beam profiler 87.

### 10. Variation of Optical Apparatus

A variation of the optical apparatus 41 will next be described. The optical apparatus 41 according to the present variation differs from that in the first embodiment only in the configurations of the illumination optical system 50 and the projection optical system 60.

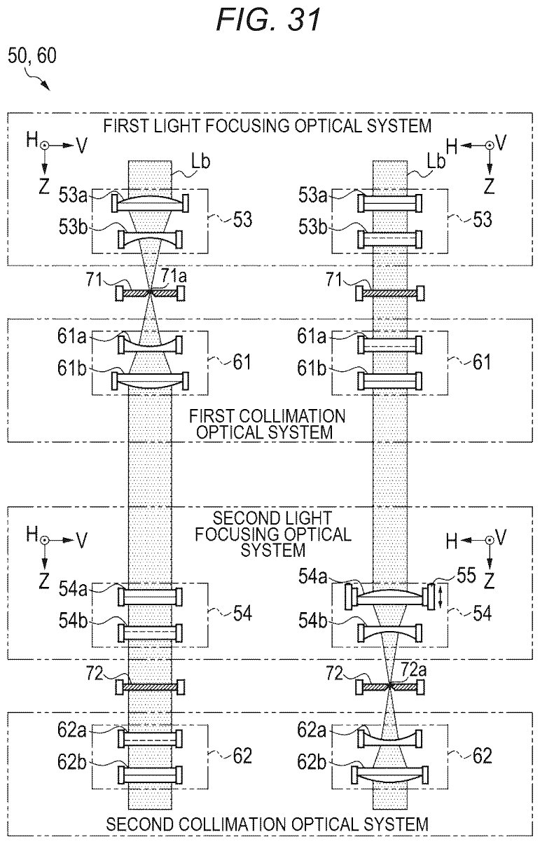

FIG. 31 partially shows the illumination optical system 50 and the projection optical system 60 according to the variation. In each of the embodiments described above, the projection optical system 60 is disposed downstream from the illumination optical system 50. In the present variation, the first light focusing optical system 53, the first collimation optical system 61, the second light focusing optical system 54, and the second collimation optical system 62 are arranged in this order in the traveling direction of the laser light Lb, as shown in FIG. 31. The first optical slit 71 is disposed between the first light focusing optical system 53 and the first collimation optical system 61, and the second optical slit 72 is disposed between the second light focusing optical system 54 and the second collimation optical system 62.

The second light focusing optical system 54 is provided with the actuator 55, which can change the distance between the cylindrical convex lens 54a and the cylindrical concave lens 54b, as in the first variation of the first embodiment.

As described above, the illumination optical system 50 and the projection optical system 60 are each divided into two, one for the V direction and the other for the H direction in the present variation. In the present variation, the optical path is longer than that in the first embodiment, but focusing the laser light Lb in the V direction and focusing the laser light Lb in the H direction are performed completely separately, so that the fluence at the first optical slit 71 and the second optical slit 72 can be made smaller.

Note that the second light focusing optical system 54, the second collimation optical system 62, the first light focusing optical system 53, and the first collimation optical system 61 may be arranged in this order in the traveling direction of the laser light Lb.

### 11. Method for Manufacturing Electronic Devices

The laser processing method according to each of the embodiments and variations described above is applicable to formation of a through hole in a glass substrate that forms an interposer 102 in manufacture of electronic devices 100 described below.

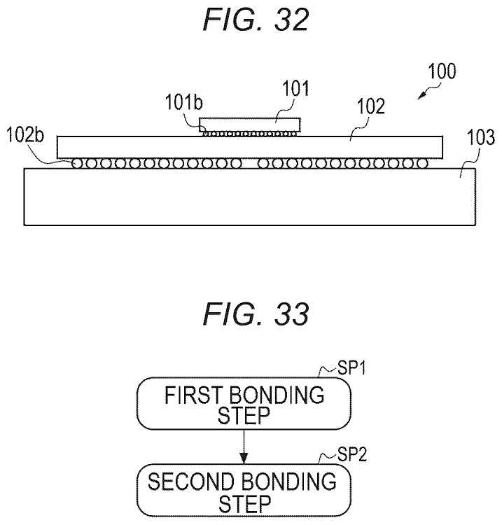

FIG. 32 diagrammatically shows the configuration of each of the electronic devices 100. The electronic device 100 shown in FIG. 32 includes an integrated circuit chip 101, the interposer 102, and a circuit substrate 103. The integrated circuit chip 101 is, for example, a chip-shaped integrated circuit substrate that is a silicon substrate in which an integrated circuit is formed. The integrated circuit chip 101 is provided with multiple bumps 101b electrically connected to the integrated circuit.

The interposer 102 includes an insulating glass substrate having multiple through holes formed therein, and a conductor that electrically connects the front and rear sides of the glass substrate is provided in each of the through holes. Multiple lands to be connected to the bumps 101b provided in the integrated circuit chip 101 are formed at one surface of the interposer 102, and the lands are each electrically connected to one of the conductors in the through holes. Multiple bumps 102b are provided at the other surface of the interposer 102, and the bumps 102b are each electrically connected to one of the conductors in the through holes.

Multiple lands to be connected to the respective bumps 102b are formed at one surface of the circuit substrate 103. The circuit substrate 103 further includes multiple terminals to be electrically connected to the lands.

FIG. 33 shows a method for manufacturing the electronic devices 100. The method for manufacturing the electronic devices 100 in the present description includes a first bonding step SP1 and a second bonding step SP2, as shown in FIG. 33. In the first bonding step SP1, the integrated circuit chip 101 is bonded to the interposer 102. Specifically, the bumps 101b of the integrated circuit chip 101 are placed on the respective lands of the interposer 102, and the bumps 101b are electrically connected to the lands. The integrated circuit chip 101 is thus electrically connected to the interposer 102.

In the second bonding step SP2, the interposer 102 is bonded to the circuit substrate 103. Specifically, the bumps 102b of the interposer 102 are placed on the respective lands of the circuit substrate 103, and the bumps 102b are electrically connected to the lands. The integrated circuit chip 101 is thus electrically connected to the circuit substrate 103 via the interposer 102. The electronic devices 100 are manufactured through the steps described above.

### 12. Example of Configuration of Laser Processing Processor

In the present disclosure, the laser processing processor 40 is constituted, for example, by a CPU (central processing unit). The laser processing processor 40 executes the variety of processes described above based on programs stored in a memory. Part or entirety of the functions of the laser processing processor 40 may be achieved by using an integrated circuit typified by an FPGA (field programmable gate array) and an ASIC (application specific integrated circuit). The laser processing processor 40 causes the memory to store the variety of data described above.

The description above is intended to be illustrative and the present disclosure is not limited thereto. Therefore, it would be obvious to those skilled in the art that various modifications to the embodiments of the present disclosure would be possible without departing from the spirit and the scope of the appended claims.

The terms used throughout the present specification and the appended claims should be interpreted as non-limiting terms. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of any thereof and any other than A, B, and C.

What is claimed is:

1. A laser processing apparatus for performing drilling by irradiating a workpiece with laser light output from a laser apparatus, the laser processing apparatus comprising:
a first optical slit disposed at a first position in an optical path of the laser light and having an opening extending in a second direction perpendicular to a first direction;
a second optical slit disposed at a second position different from the first position in the optical path of the laser light and having an opening extending in the first direction;
an illumination optical system including a first light focusing optical system configured to focus the laser light in the first direction so as to form laser light having a first linear shape and irradiate the first optical slit with the laser light, and a second light focusing optical system configured to focus the laser light in the second direction so as to form laser light having a second linear shape and irradiate the second optical slit with the laser light; and
a projection optical system configured to bring the laser light passing through the first and second optical slits into focus at a surface of the workpiece in such a way that the focused laser light have a shape of a portion where the opening of the first optical slit and the opening of the second optical slit overlap with each other.

2. The laser processing apparatus according to claim 1,
wherein the projection optical system includes
a first collimation optical system configured to collimate the laser light passing through the first optical slit in the first direction,
a second collimation optical system configured to collimate the laser light passing through the second optical slit in the second direction,
an imaging optical system configured to bring the laser light passing through the first and second optical slits into focus at the surface of the workpiece, and
a diaphragm disposed between the first optical slit and the imaging optical system and between the second optical slit and the imaging optical system.

3. The laser processing apparatus according to claim 2,
wherein the first and second collimation optical systems have the same focal length, and
the first and second collimation optical systems are so disposed that the first optical slit is located at a front focal position of the first collimation optical system and the second optical slit is located at a front focal position of the second collimation optical system.

4. The laser processing apparatus according to claim 2,
wherein the diaphragm has a shape of a pincushion that is symmetrical with respect to the first and second directions.

5. The laser processing apparatus according to claim 2,
wherein the opening of the first optical slit has a shape of a barrel that is symmetrical with respect to the first direction, and the opening of the second optical slit has a shape of a barrel that is symmetrical with respect to the second direction.

6. The laser processing apparatus according to claim 2,
wherein the first and second collimation optical systems each include a cylindrical convex lens.

7. The laser processing apparatus according to claim 2,
wherein the first and second collimation optical systems each include a unit lens that is a combination of a cylindrical convex lens and a cylindrical concave lens.

8. The laser processing apparatus according to claim 2, further comprising
a diffractive optical element disposed between the diaphragm and the imaging optical system and configured to divide the laser light passing through the diaphragm into multiple beams.

9. The laser processing apparatus according to claim 1,
wherein the projection optical system includes
a first collimation optical system configured to collimate the laser light passing through the first optical slit in the first direction,
a second collimation optical system configured to collimate the laser light passing through the second optical slit in the second direction,
a diaphragm disposed in the optical path of the laser light passing through the first and second optical slits, and
a diffractive optical element configured to divide the laser light passing through the diaphragm into multiple beams and bring an image of each of the beams into focus at the surface of the workpiece.

10. The laser processing apparatus according to claim 1,
wherein the first and second light focusing optical systems each include a cylindrical convex lens.

11. The laser processing apparatus according to claim 1,
wherein the first and second light focusing optical systems each include a unit lens that is a combination of a cylindrical convex lens and a cylindrical concave lens.

12. The laser processing apparatus according to claim 1, further comprising
a beam steering apparatus configured to adjust a position of an optical axis of the laser light that enters the illumination optical system.

13. The laser processing apparatus according to claim 1,
wherein the opening of the first optical slit has a variable first slit width that is a width in the first direction,
the opening of the second optical slit has a variable second slit width that is a width in the second direction, and
the laser processing apparatus further includes a processor configured to control the first and second slit widths in accordance with a target value of a diameter of a hole to be processed in the workpiece.

14. The laser processing apparatus according to claim 13, further comprising:
a first actuator configured to move the first light focusing optical system; and
a second actuator configured to move the second light focusing optical system,
wherein the processor is configured to
control the first actuator to shift a beam waist position of the laser light in the first direction from the first position when the first slit width becomes greater than a beam waist full width of the laser light in the first direction, and
control the second actuator to shift a beam waist position of the laser light in the second direction from the second position when the second slit width becomes greater than the beam waist full width of the laser light in the second direction.

15. The laser processing apparatus according to claim 13, further comprising
a variable-magnification beam expander disposed upstream from the illumination optical system,
wherein the processor is configured to
control a magnification of the beam expander in such a way that the first slit width is smaller than or equal to a beam waist full width of the laser light in the first direction and the second slit width is smaller than or equal to the beam waist full width of the laser light in the second direction when the first slit width is greater than the beam waist full width of the laser light in the first direction or when the second slit width is greater than the beam waist full width of the laser light in the second direction.

16. The laser processing apparatus according to claim 2,
wherein a numerical aperture of the imaging optical system falls within a range from 0.03 to 0.06.

17. The laser processing apparatus according to claim 16,
wherein a projection magnification of the projection optical system falls within a range from 1/30 to 1/10.

18. The laser processing apparatus according to claim 17,
wherein an expression NAil=NAi×Mg is satisfied,
where NAi represents the numerical aperture of the imaging optical system, Mg represents the projection magnification of the projection optical system, and NAil represents a numerical aperture of each of the first and second light focusing optical systems.

19. A laser processing system for performing drilling by irradiating a workpiece with laser light output from a laser apparatus, the laser processing system comprising:
the laser apparatus configured to output the laser light;
a first optical slit disposed at a first position in an optical path of the laser light and having an opening extending in a second direction perpendicular to a first direction;
a second optical slit disposed at a second position different from the first position in the optical path of the laser light and having an opening extending in the first direction;
an illumination optical system including a first light focusing optical system configured to focus the laser light in the first direction so as to form laser light having a first linear shape and irradiate the first optical slit with the laser light, and a second light focusing optical system configured to focus the laser light in the second direction so as to form laser light having a second linear shape and irradiate the second optical slit with the laser light; and
a projection optical system configured to bring the laser light passing through the first and second optical slits into focus at a surface of the workpiece in such a way that the focused laser light have a shape of a portion where the opening of the first optical slit and the opening of the second optical slit overlap with each other.

20. The laser processing system according to claim 19,
wherein the laser apparatus is a discharge-excitation-type laser apparatus, and a discharge direction corresponds to the first direction.

21. The laser processing system according to claim 20,
wherein the first position is a beam waist position of the laser light in the first direction, and
the second position is a beam waist position of the laser light in the second direction.

22. The laser processing system according to claim 20,
wherein the laser apparatus is an excimer laser apparatus and includes an unstable resonator that is unstable only in the discharge direction.

23. The laser processing system according to claim 20,
wherein the laser apparatus is an excimer laser apparatus and includes an unstable resonator that is unstable in the discharge direction and in a direction perpendicular to the discharge direction.

24. The laser processing system according to claim 23,
wherein an expansion factor by which the unstable resonator expands the laser light falls within a range from 5 times to 10 times.

25. A method for manufacturing electronic devices, the method comprising:
forming multiple through holes in a glass substrate as a workpiece by using a laser processing apparatus configured to perform drilling by irradiating the workpiece with laser light output from a laser apparatus;
coupling and electrically connecting an interposer including the glass substrate and a conductor provided in each of the multiple through holes to an integrated circuit chip; and
coupling and electrically connecting the interposer to a circuit substrate,
the laser processing apparatus including
a first optical slit disposed at a first position in an optical path of the laser light and having an opening extending in a second direction perpendicular to a first direction,
a second optical slit disposed at a second position different from the first position in the optical path of the laser light and having an opening extending in the first direction,
an illumination optical system including a first light focusing optical system configured to focus the laser light in the first direction so as to form laser light having a first linear shape and irradiate the first optical slit with the laser light, and a second light focusing optical system configured to focus the laser light in the second direction so as to form laser light having a second linear shape and irradiate the second optical slit with the laser light, and
a projection optical system configured to bring the laser light passing through the first and second optical slits into focus at a surface of the workpiece in such a way that the focused laser light have a shape of a portion where the opening of the first optical slit and the opening of the second optical slit overlap with each other.
